(19) United States
(12) Patent Application Publication
(10) Pub. No.: US 2019/0374799 A1
(43) Pub. Date: Dec. 12, 2019

(54) FIRE PROTECTION ELEMENT

(71) Applicant: Hilti Aktiengesellschaft, Schaan (LI)

(72) Inventors: Herbert MÜNZENBERGER, Wiesbaden (DE); Andreas OBER, Kaufering (DE)

(73) Assignee: Hilti Aktiengesellschaft, Schaan (LI)

(21) Appl. No.: 16/472,301

(22) PCT Filed: Feb. 7, 2018
(86) PCT No.: PCT/EP2018/052988

§ 371 Date: Jun. 21, 2019

(30) Foreign Application Priority Data
Feb. 22, 2017 (EP) 17157380.1

(51) Int. Cl. A62C 2/06; F16L 5/04

(52) U.S. Cl. CPC A62C 2/065; A62C 3/16; F16L 5/04

(57) ABSTRACT

A fire protection element is useful for the separation of openings passing through walls or ceilings, in particular of line passages. The fire protection element has a core consisting of a filling material and a frame. The frame surrounds the core at least in some sections in a circumferential direction and is fixedly connected to the core. Furthermore, the frame is made from an intumescent material and has a reinforcing element.

The invention relates to a fire-protection element for sealing of openings, especially of line passages, that are routed through walls or ceilings, having a core of filling material and a frame.

Fire-protection elements, which are capable of sealing line passages of non-fire-resistant pipes or cables in ceilings or walls in the fire situation, in order to prevent the spread of fire and smoke in buildings, are known in the most diverse configurations. The fire-protection elements usually contain an intumescent material, which is disposed around the lines, and a reinforcing element, which stabilizes the intumescent material and in the fire situation prevents or delays loss of the protective ash crust.

A disadvantage of the known fire-protection elements is that they either possess a complex structure and therefore are expensive to manufacture or are simply structured but as a result have only moderate fire-protection properties. Furthermore, correct assembly of the fire-protection elements is often difficult and readily leads to errors, which reduce the fire-protection properties of the fire-protection element.

The object of the invention is to provide a fire-protection element that can be manufactured inexpensively and assembled easily, so that errors of use are largely ruled out.

To solve the object, a fire-protection element for sealing of openings, especially of line passages, that are routed through walls or ceilings, having a core of filling material and a frame is provided, wherein the frame surrounds the core at least in portions in a peripheral direction and is joined securely to the core. The frame is formed from an intumescent material and is provided with a reinforcing element. Since the frame comprises the intumescent material, which in the fire situation is intended for sealing of the opening, the core of filling material is completely available for routing lines through it, i.e., during assembly, lines may be routed through the fire-protection element at any position and substantially over the entire width and height of the core, without substantially impairing the fire-protection properties of the fire-protection element. In this way, simple and safe assembly of the fire-protection element is assured. The filling material fills the frame substantially completely and hereby ensures smoke-tightness and sound insulation of the fire-protection element. In the fire situation, the frame ensures directed expansion of the intumescent material and stabilizes the intumescent crust. Furthermore, the simple design of the fire-protection element permits inexpensive manufacture.

The frame is preferably made in one piece. This offers the advantage that only few transition regions, in which intumescent material and/or filling material is able to emerge in the fire situation, are present between various portions of the frame. Furthermore, various portions of the frame stabilize one another mutually during expansion of the intumescent material, and so the structural integrity of the fire-protection element is improved by this configuration.

The filling material may contain substantially no fire-protection additives. Since the frame of intumescent material delivers the fire-protection properties of the fire-protection element, a filling material containing little or no fire-protection additives may be provided. Hereby the fire-protection element can be manufactured particularly inexpensively.

Preferably, the filling material is a soft foam. Soft foams have the advantage that they may be easily perforated by a fitter in order to route lines through them for example with a lance, whereby the assembly work is accelerated.

According to a preferred embodiment, the soft foam is elastic, whereby it tightly surrounds the lines routed through the fire-protection element and thus ensures particularly good smoke-tightness and/or sound insulation.

In an alternative embodiment, the filling material may be a hard foam, in order to make the fire-protection element more stable.

The intumescent material is preferably a hard foam, especially having a density of 100 kg/m³ to 600 kg/m³, preferably having a density of 200 kg/m³ to 500 kg/m³.

It is of advantage when the frame has an intumescent volume that is provided for sealing, in the fire situation, the cross section formed by the frame. In this way, it is ensured that the intumescent material is sufficient to seal the opening to be sealed safely in the fire situation and to ensure effective fire protection.

In a further advantageous embodiment, the reinforcing element is disposed in peripheral direction in the outer surface of the frame. In this case, the reinforcing element may also be disposed on the outer surface of the frame or may form it. In this way, the frame limits spreading of the intumescent material in the fire situation and thus makes it possible to steer the expansion of the intumescent material inward. Since the intumescent material therefore can no longer spread in uncontrolled manner in all directions, the quantity of intumescent material in the fire-protection element may be reduced, whereby lower manufacturing costs are achieved.

Preferably, the reinforcing element is formed by a panel, a mat, a mesh or a fabric, and preferably consists of metal, expanded metal, glass fibers, basalt fibers, carbon fibers or ceramic fibers. A hybrid structure of the reinforcing element comprising several materials is also possible. Compared with the intumescent material of the frame, these materials have a higher temperature resistance. This is advantageous, since the reinforcing element is not impaired by the temperature that activates the intumescent material and so is able to exert its stabilizing function in this way even in the fire situation. The use of a mat, of a mesh or of a fabric offers good joining of the reinforcing element to the intumescent material. Furthermore, a reinforcing element having such a structure retains its stabilizing properties even in the presence of isolated structural damage.

According to a further preferred embodiment, two opposite sides of the core are substantially not covered by the frame. Thus the fire-protection element may be disposed in such a way in an opening that the two uncovered sides of the core of filling material are aligned substantially parallel to the wall or the ceiling and the sides covered by the frame point in the direction of the wall or the ceiling. In this way, lines may be routed through the fire-protection element without having to perforate the frame of the fire-protection element for the purpose. This simplifies assembly and prevents damage to the frame.

The frame may have an abutting edge, which is formed by a first and an opposite second end of the frame. At this abutting edge, the frame is severed and may therefore be opened with little exertion of force, for example with a knife or screwdriver. In this way, further access to the core of filler material is provided, which may be used, in addition to the uncovered sides of the core, for installation of lines. Furthermore, removal of the fire-protection element is facilitated hereby, for example when the fire-protection element must be replaced after a fire.

The fire-protection element is preferably substantially rectangular and in particular has a substantially rectangular core. This configuration has the advantage that the fire-protection element may be used in combination with further fire-protection elements in order to form a firewall for openings, the cross section of which is larger than one side of the fire-protection element. A firewall formed in modular manner in this way may be configured, for example, as a masonry wall, in which the fire-protection elements form the bricks. Furthermore, a rectangular fire-protection element can be manufactured inexpensively and may be stored as well as transported in a manner making more efficient use of space.

Further advantages and features will become obvious from the description hereinafter in conjunction with the attached drawings, wherein:

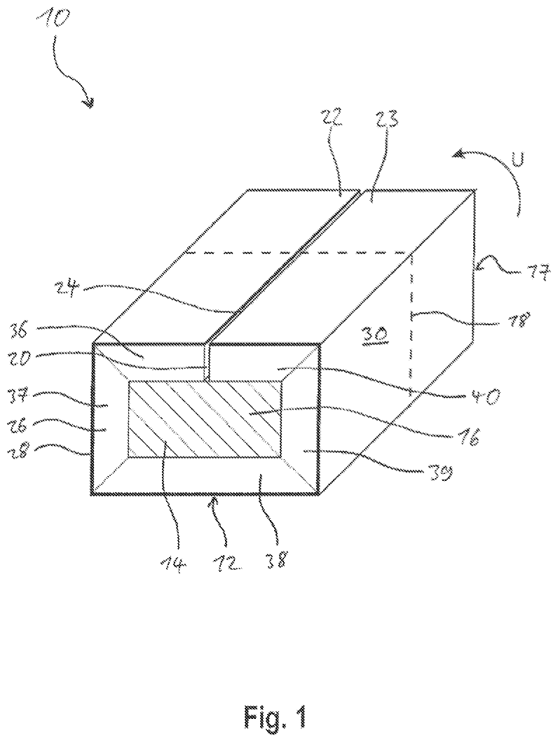

FIG. 1 shows a perspective diagram of an inventive fire-protection element having a frame,

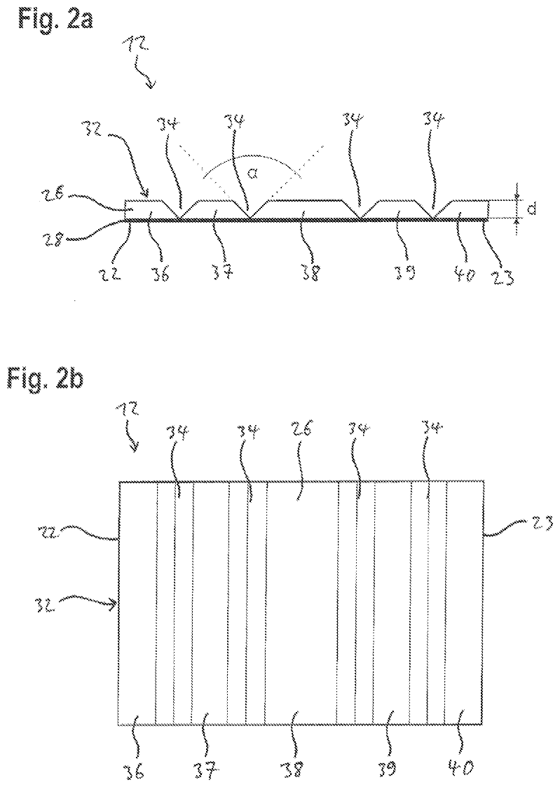

FIG. 2a shows a side view of the frame of the fire-protection element from FIG. 1 in developed form,

FIG. 2b shows an overhead view of the frame from FIG. 2a, and

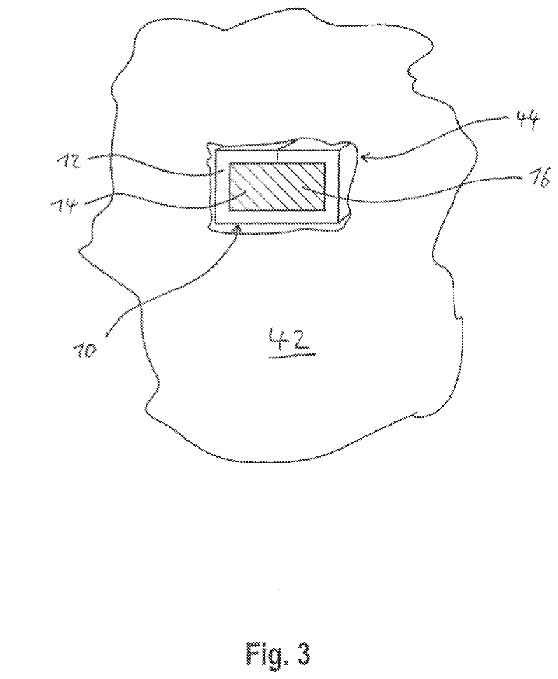

FIG. 3 shows a perspective diagram of the fire-protection element from FIG. 1, installed in an opening.

In FIG. 1, an inventive fire-protection element 10 for sealing of openings, such as line passages, that are routed through walls or ceilings, is shown that has a frame 12 and a core 14 of filling material.

Core 14 is rectangular and is enclosed in peripheral direction U by frame 12, wherein the two end faces 16, 17 of core 14 remain free. The said frame 12 extends from one end face 16 to the other end face 17 disposed opposite it. Hereby fire-protection element 10 has substantially the configuration of a rectangular block.

Frame 12 covers outer periphery 18 of fire-protection element 10 completely except for a narrow slit 20. Slit 20 is formed in this case by two oppositely disposed ends 22, 23 of frame 12, which face one another on one side of fire-protection element 10 and form an abutting edge 24.

In an alternative embodiment, frame 12 may be closed in peripheral direction U and not have any slit 20.

Frame 12 is formed from a layer 26 of intumescent hard foam and comprises a flat-shaped reinforcing element 28, which is applied on layer 26 of intumescent hard foam or at least is disposed partly in layer 26 of intumescent hard foam. In both cases, layer 26 of intumescent hard foam is joined securely to reinforcing element 28.

Layer 26 of intumescent hard foam is disposed between core 14 of filling material and reinforcing element 28, which forms the outer surface 30 of frame 12 or of fire-protection element 10 in peripheral direction U.

The intumescent hard foam from which layer 26 is formed is a PIR or PUR foam having an intumescent component comprising an acid former (e.g. APP), a carbon source or sugar polyol (e.g. Di-Penta), an NH₃-evolving gas builder (e.g. from the group comprising melamine, guanidine, melamine cyanurate), expandable graphite and optionally zinc borate and ATH.

The intumescent hard foam has a density of 200 kg/m³. Alternatively, the intumescent hard foam may have a density within the range of 100 kg/m³ to 600 kg/m³.

Layer 26 has a thickness d (see FIG. 2a) and the intumescent hard foam has an intumescent volume that ensure that the entire area of end faces 16, 17 is securely sealed in the fire situation. In this way, it is ensured that fire-protection element 10 itself then safely seals an opening in the fire situation when core 14 is pierced substantially completely by lines and/or core 14 is absent.

Reinforcing element 28 consists of a thermally stable, mechanically stress-resistant material, for example an expanded metal. In an alternative embodiment, reinforcing element 28 may be formed from a panel, a mat, a mesh or a fabric, which preferably consists of metal, glass fibers, basalt fibers, carbon fibers or ceramic fibers.

Frame 12 is made in one piece. Alternatively, frame 12 may be formed from several portions joined to one another.

The filling material of core 14 is a PUR soft foam, which contains no fire-protection additives and is substantially sound-insulating and smoke-tight.

In an alternative embodiment, the filling material of core 14 is a PUR hard foam, which contains no fire-protection additives and is substantially sound-insulating and smoke-tight.

Core 14 is joined tightly and securely, preferably by substance-to-substance bond, to frame 12. Hereby it is ensured that the filling material is not forced out of frame 12 when a line is routed through the filling material or a penetration for a line is formed in the filling material. Furthermore, the smoke-tightness and sound-insulating ability of fire-protection element 10 are ensured in this way.

It is of advantage when the filling material of core 14 can be distinguished easily from the intumescent material of frame 12, for example by a different, preferably contrasting color. In this way it is obvious to the fitter which region is intended for routing lines, whereby errors of use, such as removal of intumescent material from frame 12, are avoided.

For manufacture of fire-protection element 10, frame 12 is first fabricated in the form of a panel 32 having depressions 34 in layer 26 of intumescent hard foam (see FIGS. 2a and 2b).

For this purpose, reinforcing element 28 is first placed on the bottom of a first mold. Then the first mold is filled with the intumescent hard foam and sealed with a cover having corresponding wedge-shaped ridges for depressions 34.

Layer 26 of intumescent hard foam now has four depressions 34, which extend in parallel manner to the two ends 22, 23 of frame 12 and which subdivide panel 32 into five segments 36, 37, 38, 39, 40.

Depressions 34 extend as far as reinforcing element 28 and subdivide layer 26 of intumescent hard foam. Alternatively, depressions 34 may be made more shallow and not subdivide layer 26 of intumescent hard foam completely. Depressions 34 function as predetermined bending points and for this reason must be made at least deep enough that panel 32 can be folded easily and in well-defined manner at these depressions 34.

Depressions 34 are wedge-shaped and have an angle α of 90°. In an alternative embodiment, depressions 34 may also have differently shaped cross sections, for example a wedge shape having concave and/or convex flanks. Additionally or alternatively, the angle α may also be different from 90°, but angles α between 60° and 120° are preferred. In particular, depressions 34 in a panel 32 may also be configured differently from one another.

In order to form fire-protection element 10, panel 32 is placed in a second mold, wherein middle segment 38 is placed with reinforcing element 28 facing down on the bottom of the mold and segments 37, 39 adjoining middle segment 38 are folded upward by 90°. In this way, frame 12 forms a channel profile, which may be filled from above with core 14 of filling material. Furthermore, prior to filling, one of the outer segments 36, 40 may be folded parallel to middle segment 38.

In an alternative manufacturing method, frame 12 may also be closed first of all, i.e. folded completely to a rectangle and then filled via one of the end faces 16, 17.

After frame 12 has been filled with the filling material, frame 12 as well as the second mold is closed and fire-protection element 10 is finished.

Core 14 of filling material may be a molded part that completely fills frame 12. Preferably, core 14 as a molded part has a small oversize, so that core 14 is held in frame 12 by means of press fit and gaps are securely sealed.

Slit 20 may be sealed by a suitable fire-protection means, for example an intumescent inlay, and/or sprayed with an intumescent foam material.

Alternatively, core 14 may be formed by a foam material introduced into frame 12. If core 14 is provided as a foam material, frame 32 is formed first of all and then the inside space of frame 32 is sprayed with the filling material. Spraying of the inside space of frame 32 with the filling material may also be carried out first on site, especially after frame 32 has already been inserted into opening 44 to be sealed (see FIG. 3).

In an alternative manufacturing method, the first and second molds may be replaced by a single adjustable mold or corresponding retaining elements, whereby the manufacturing method is further simplified.

In FIG. 3, a detail of a wall 42 having an opening 44 is shown, in which a fire-protection element 10 is installed as a firewall.

Fire-protection element 10 is disposed such that end face 16 is aligned substantially parallel to wall 42 and the sides covered by frame 12 point in the direction of wall 42. In this way, lines may be routed through fire-protection element 10 without damaging frame 12 in the process.

In order to route lines through fire-protection element 10, a penetration through which the line may be pushed may be created in core 14 of filling material, by means of a lance, for example.

With the inventive fire-protection element 10, a fire-protection element is provided that can be manufactured simply and inexpensively, installed simply and without errors, and is sound-insulating and smoke-tight from the very beginning.

1. A fire-protection element for sealing of openings, that are routed through walls or ceilings, comprising:
a core of filling material, and
a frame,
wherein the frame surrounds the core at least in portions in a peripheral direction and is joined securely to the core,
wherein the frame is formed from an intumescent material and is provided with at least one reinforcing element.

2. The fire-protection element according to claim 1, wherein the filling material contains substantially no fire-protection additives.

3. The fire-protection element according to claim 1, wherein the filling material is a soft foam.

4. The fire-protection element according to claim 1, wherein the intumescent material is a hard foam.

5. The fire-protection element according to claim 1, wherein the frame has an intumescent volume that is provided for sealing, in a fire, a cross section formed by the frame.

6. The fire-protection element according to claim 1, wherein the reinforcing element is disposed in the peripheral direction in an outer surface of the frame.

7. The fire-protection element according to claim 1, wherein the reinforcing element is formed by a panel, a mat, a mesh or a fabric, or combinations thereof.

8. The fire-protection element according to claim 1, wherein two opposite sides of the core are substantially not covered by the frame.

9. The fire-protection element according to claim 1, wherein the frame has an abutting edge formed by a first end and an opposite second end of the frame.

10. The fire-protection element according to claim 1, wherein the fire-protection element is substantially rectangular.

11. The fire-protection element according to claim 4, wherein the hard foam has a density of 100 kg/m³ to 600 kg/m³.

12. The fire-protection element according to claim 7, wherein the reinforcing element comprises at least one material selected from the group consisting of metal, expanded metal, glass fibers, basalt fibers, carbon fibers and ceramic fibers.

13. The fire-protection element according to claim 10, wherein the fire-protection element has a substantially rectangular core.

14. The fire-protection element according to claim 1, wherein the frame consists of a single piece.

15. The fire-protection element according to claim 3, wherein the soft foam is elastic.
